(19) United States
(12) Patent Application Publication
(10) Pub. No.: US 2014/0214921 A1
(43) Pub. Date: Jul. 31, 2014

(54) SYSTEM AND METHOD FOR IDENTIFICATION OF AN APPLICATION EXECUTED ON A MOBILE DEVICE

(71) Applicant: Onavo Mobile Ltd., Menlo Park, CA (US)

(72) Inventors: Roi TIGER, Tel Aviv (IL); Nimrod PRIELL, Tel Aviv (IL); Eran FRIDMAN, Neve Yarak (IL); Gadi ELIASHIV, Tel Aviv (IL)

(73) Assignee: Onavo Mobile Ltd., Menlo Park, CA (US)

(21) Appl. No.: 13/870,335

(22) Filed: Apr. 25, 2013

Related U.S. Application Data
(60) Provisional application No. 61/758,794, filed on Jan. 31, 2013.

(51) Int. Cl. H04L 29/08

(52) U.S. Cl. CPC H04L 67/02
USPC 709/203

(57) ABSTRACT

A method for uniquely identifying an application executed on a mobile device is provided. The method comprises trapping a request to execute an application by the mobile device, wherein the request is initiated by the application and directed to an Internet resource associated with the application; identifying a source of the request; generating metadata respective of the application initiated the request; and sending the metadata to the a proxy server communicatively connected to the mobile device, wherein the proxy server is configured to uniquely identify a name and a type of the application by matching information in the metadata to an app-index. This is subject to a user's privacy, opt-in, or opt-out settings.

### CROSS REFERENCE TO RELATED APPLICATIONS

This application claims the benefit of U.S. Provisional Application No. 61/758,794 filed on Jan. 31, 2013, the contents of which are herein incorporated by reference.

### TECHNICAL FIELD

The invention generally relates to applications executed on a mobile device that request access to the web, and more specifically to identification of such applications remotely of the mobile device.

### BACKGROUND

The use of mobile devices such as smart phones, mobile phones, tablet computers, and other handheld devices has significantly increased. Such mobile devices allow access to a variety of application programs. Application programs, also known as applications, or for short “apps”, are usually designed to help a user of a mobile device to perform a specific task. Applications may be bundled with the computer and its system software, or may be accessible and sometimes downloadable from a central repository such as, for example, the App Store™ by Apple®.

Typically, each application communicates over the Internet independent of any other application executed on the mobile device. That is, there may be a browser, an e-mail program, a Facebook® app, a Skype® app, and so on, each communicating independently with a remote server over the Internet. Hence, each application communicates separately and independently with a remote server based on its configuration. It is therefore difficult to provide coherent information with respect of the communication of a mobile device as each of the applications operates independently.

Naturally, application developers are interested in identifying the type of applications executed on the mobile device. Such information would help developers to determine, for example, which of their applications have been accessed versus the applications of their competitors. It should be noted that an indication about the number of applications that were actually executed is different than the number of the applications that were downloaded from the central repository.

As is well-known in the art, users may be given the option within privacy settings, or otherwise, to opt-in or opt-out of various features, such as the collection of browsing information, location information, or other information about a mobile device. For instance, during a configuration process, a user may be asked to specifically opt-in to the identification and collection of information relating to their mobile device. Similarly, the user may be required to specifically opt-in before information about their device is transmitted from the device to a remote server. Alternatively, a user may be provided an opportunity to opt-out of the identification and collection of information relating their device, or the transmission of information about their device to a remote server.

As each application communicates separately and independently with a remote server, the task of identifying the type of applications executed on a mobile device is complicated.

It would be therefore advantageous to provide a solution that overcomes the limitations of the prior art by allowing identification of mobile applications being executed on a mobile device.

### BRIEF DESCRIPTION OF THE DRAWINGS

The subject matter disclosed herein is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic diagram of a system utilized to describe the various disclosed embodiments;

FIG. 2 is a schematic diagram describing a method for identifying execution of applications on a mobile device in accordance with one embodiment; and

FIG. 3 is a flowchart describing a method for identifying applications executed over a mobile device in accordance with one embodiment.

### SUMMARY

Certain embodiments disclosed herein include a method for uniquely identifying an application executed on a mobile device. The method comprises trapping a request to execute an application by the mobile device, wherein the request is initiated by the application and directed to an Internet resource associated with the application, subject to a user's privacy, opt-in, or opt-out settings; identifying a source of the request; generating metadata respective of the application initiated the request; and sending the metadata to the a proxy server communicatively connected to the mobile device, wherein the proxy server is configured to uniquely identify a name and a type of the application by matching information in the metadata to an app-index.

Certain embodiments disclosed herein also include a method for uniquely identifying an application executed on a mobile device, subject to a user's privacy, opt-in, or opt-out settings, the method is performed by at least a proxy server communicatively connected to the mobile device and a plurality of Internet resources via a network. The method comprises receiving a request for a network setting initiated by an application launched on the mobile device; generating a customized proxy auto-config code; sending the customized proxy auto-config code to the mobile device, wherein the execution of the customized proxy auto-config code by the mobile device allows accessing information stored in the mobile device about the launched application; receiving a domain name server (DNS) generated responsive of the execution of the customized proxy auto-config code; and analyzing the DNS request to identify at least a name and type of the launched application.

### DETAILED DESCRIPTION

The embodiments disclosed herein are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

The disclosed techniques allow identification of applications executed on a mobile device that access a remote server over a network. Accordingly, one or more parameters representative of an executed application is identified allowing the determination of which application requested access to the network. In addition, traffic characteristics related to the executed application are extracted allowing the identification of the application executed on the mobile device.

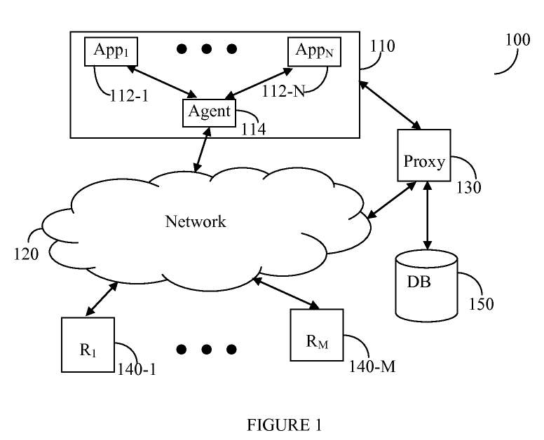

FIG. 1 depicts an exemplary and non-limiting schematic diagram of a network system 100 utilized to describe the various disclosed embodiments. A mobile device 110, which may be a smart phone, a mobile phone, a tablet computer, a personal computer (PC) and the like is installed with applications (apps) APP, 112-1 through APPN 112-N. The mobile device 110 is communicatively connected to a network 120 which may be a local area network (LAN), a wide area network (WAN), a metro area network (MAN), the Internet, the worldwide web (WWW), a wireless network, a wired network, a cellular network, the like, and any combinations thereof.

In accordance with one embodiment, an agent 114 is installed on the mobile device 110 and is configured to trap all communications from any of the apps 112-1, 112-N on the mobile device 110 to any one of a plurality of Internet resources R₁ 140-1 through R_{M} 140-M that are communicatively connected to the network 120, subject to a user's privacy, opt-in, or opt-out settings. As a result, all communications to and from any one of the apps 112-1, 112-N is performed via the agent 114. The agent 114 is communicatively connected to a proxy server 130.

As previously discussed within the Background, functionality may be subject to well-known opt-in or opt-out settings, or other privacy settings commonly used within the art. For instance, trapping communications from the apps 112-1, 112-N on the mobile device 110 to any one of a plurality of Internet resources Ri 140-1 through R_{M} may only be initiated once a user has been informed of this behavior and explicitly opted-in. Alternatively, trapping communications may only be initiated once a user has been provided the opportunity to opt-out of the communication trapping. In this manner, users may be notified of data collection techniques and given the option to opt-in or opt-out of any or all data collection on the mobile device 110.

The agent 114 may be an application (app) installed on the mobile device 110 and executed thereon. According to this embodiment, the agent 114 traps a request to access an Internet resource 140 by an app 112, for example, the app 112-1. The agent 114 traps the request (subject to a user's privacy, opt-in, or opt-out settings), identifies the source of the request, and generates metadata respective of the app 112-1 in response to the trapped request. In one embodiment, the source of the request is identified by querying the operation system of the mobile device about the socket from which the response was generated.

Typically, in order to provide an access to the Internet resource, a socket is opened for the communication of the app with the Internet resource. The operating system maintains information that identifies which app has opened which socket.

The metadata generated by the agent 114 may include, but is not limited to, a hypertext transfer protocol (HTTP) header of a request generated by the app 112, or network parameters included in the HTTP header, e.g., a requested URL or a destination IP address of an Internet resource 140, an active socket, and so on.

According to one embodiment, metadata also includes an app identification referred to as a bundle name. The bundle name is a name assigned by the application developer. For example, the bundle name “com.ExampleApplication.extend”, is for an application named “ExampleApplication”. For different versions of the same application type the bundle name may be the same name. For example, the bundle name “.com.game.kids” may refer be of two different applications “games pro” and “games light”. The bundle name is extracted by the agent 114 and added to the metadata.

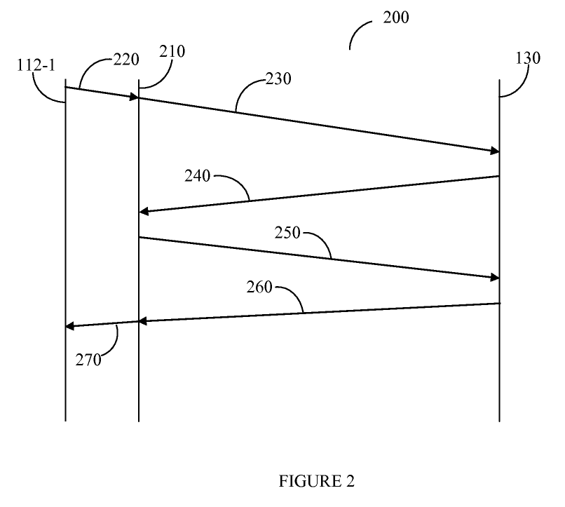

The generated metadata is sent to the proxy server 130 by the agent 114. In addition, all requests generated by apps 112 and trapped by the agent 114 are forwarded to the proxy server 130 or sent directly to their destination. In one embodiment, the proxy server 130 is utilized merely to identify the apps 112 executed over the mobile device 110. Therefore, the communication requests generated by apps 112 can be sent directly to their destination servers and are not relayed through the proxy server 130. In another embodiment, discussed in detail with reference to FIG. 2, the agent 114 configures a network interface (not shown) of the mobile device 110 to relay all communications from and to the apps 112 through the proxy server 130.

As previously discussed within the Background, the aforementioned functionality may be subject to well-known opt-in or opt-out settings, or other privacy settings commonly used within the art. For instance, communication requests generated by apps 112 may only be transmitted to or through the proxy server 130 after the user has explicitly opted-in to the communication requests being monitored. Alternatively, communication requests generated by apps 112 may only be transmitted to or through the proxy server 130 after the user has been provided the opportunity to opt-out of the communication requests being monitored.

The proxy server 130 identifies the app 112 requesting an access to the network based on the received metadata. With this aim, the proxy server 130 analyzes the metadata to determine which information is included therein. Then the proxy server 130 matches the information extracted from the metadata to an app-index maintained in a database 150. The app-index is populated to provide an association between a unique application name and type to one or more parameters included in a request to a remote server sent by an app 112 to a remote server.

In an exemplary embodiment, at least one of: a URL, an IP address, a domain name server (DNS) name of the remote server as well as the bundle name are mapped to an application name and type. For example, the bundle names “com.ExampleApplication.extend” and/or “com.ExampleApplication.count” and the URL “www.ExampleApplication.com.extend” are mapped to the application (app) name “ExampleApplication”. Therefore, by matching the received metadata against the app-index the respective app requesting an access to the network 120 and executed on the mobile device 110 can be uniquely identified.

The name and type of the identified app 112 including the metadata are saved in the database 150. The database 150 may be directly connected to the proxy server 130 or through the network 120.

The proxy server 130 communicates with the plurality of Internet resources 140 through a first interface and with the mobile device 110 and the applications executed thereon through a second interface. The first and second interfaces may be realized using a network interface card (NIC). The proxy server 130 also includes a processor connected to the interfaces and a memory. The memory contains instructions that when executed by the processor cause unique identification of the executed applications according to the disclosed techniques.

According to another embodiment, the unique identification of apps 112 executed over the mobile device 110 is performed without the generation of metadata by the agent 114, and in particular the agent 114 may not be installed in the mobile device 110. According to this embodiment, the proxy server 130 continuously monitors the communication of the mobile device 110, subject to a user's privacy, opt-in, or opt-out settings. Upon identification of a request for communication with an Internet resource 140 sent by an app 112 installed on the mobile device 110, the proxy server 130 is configured to generate the extracted communication parameters that can be utilized to identify the app 112 requesting communication with a remote server.

This embodiment is now described with reference to FIG. 2 which shows an exemplary and non-limiting schematic communication diagram 200 between an app 112-1 and the proxy 130. Typically, an operating system (OS) of the mobile device 110 (FIG. 1) facilitates the communication with the Internet Resources 140-1 and 140-M (FIG. 1) by means of a network interface 210. The network interface 210 may be a component of the operating system or a hardware component of the mobile device 110.

In order to launch an app 112-1 installed on the mobile device 110, a preliminary request 220 is sent to a remote server (e.g., an Internet resource Ri 140-1) through the network interface 210 by the app 112-1. The preliminary request 220 is typically a HTTP request that includes at least the app's 112-1 bundle name.

Respective thereto, the network interface 210 forwards a request 230 for network settings to the proxy server 130 over the network 120 (FIG. 1). The request 230 is essentially the preliminary request 220. Thus, the request 230 for network settings also includes the bundle name of the app 112-1 generated the request 220. In one embodiment, the network interface 210 is configured by a network carrier to direct the requests 220 generated by any launched app 112 to the network proxy 210. Such configuration may be performed during activation of the mobile device 110 or when the device is connected to a data network of the network carrier.

Respective of the request 230, the proxy server 130 sends a customized proxy auto-config code (PAC) 240 to the network interface 210. The customized PAC defines how the network interface 210 can automatically choose the appropriate server (Internet Resource) for fetching a requested uniform resource locator (URL). As the PAC code 240 runs locally on the mobile device 110, the code can access local information about the apps 112-1, 112-N executed on the mobile device 110. In an exemplary embodiment, the customized PAC code is defined as follows:

function FindProxyForURL(url, host) {
return ″PROXY myproxy.com:8080; DIRECT″;

The network interface 210 then executes the customized PAC 240 and sends a domain name system (DNS) request 250 to the proxy server 130, in response to the customized PAC 240. The DNS request 250 includes at least the URL and host name of an Internet Resource 140 to which the app 112-1 wished to connect.

By analyzing the DNS request 250, the proxy server 130 identifies the name and type of the application 112-1 which was launched over the mobile device 110. The name and type of the identified app 112-1 are saved in a database, e.g., database 150.

Respective thereto, the proxy server 130 sends an IP address 260 of the Internet resource requested by the app 112-1, to the network interface 210. The IP address 260 is forwarded to the app 112-1 as a message 270. Thereafter, the app 112-1 can communicate directly with the Internet resource addressed by the IP address 260.

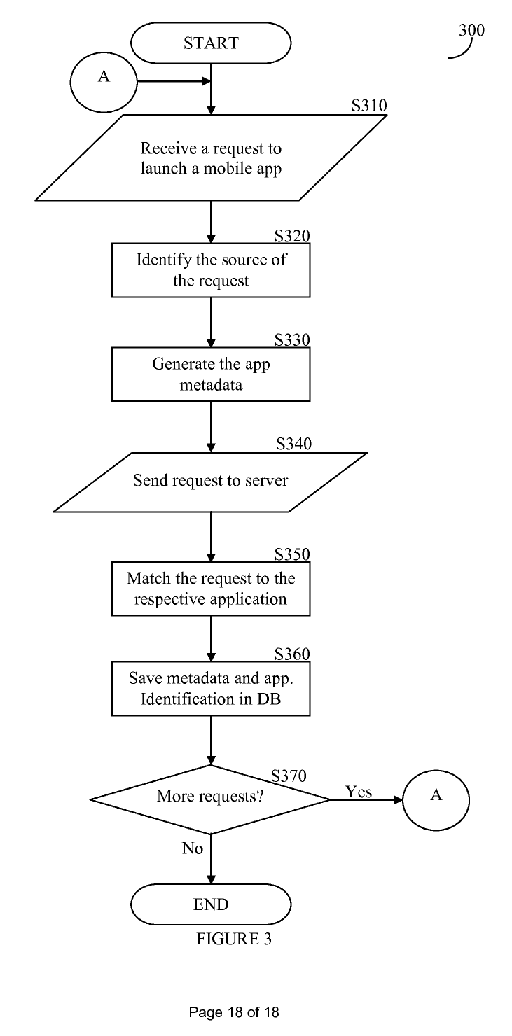

FIG. 3 depicts an exemplary and non-limiting flowchart 300 describing a method for identification of applications (apps) executed over a mobile device in accordance with one embodiment. In S310, the agent 114 receives a request to initiate communication by an application (any of apps 112-1 through 112-N) installed on a mobile device, subject to a user's privacy, opt-in, or opt-out settings. In S320, the agent 114 identifies the source of the request, i.e., the specific application (e.g., app 112-1). The identification may be of a communication socket from which the request was sent. The identification may be performed by sending a query to an operating system, for example, Apple® IOS, of the mobile device 110 regarding the identity of the active socket.

In S330, metadata respective of the requested application is generated. Such metadata may include the application's bundle name, or a HTTP header of a request generated to be sent to the app's destination server. The metadata may contain only one or more network parameters included in the HTTP header, such as, a requested URL, a destination IP address, and so on.

In S340, the agent 114 sends the trapped request together with the application metadata to the proxy server 130. In S350, the proxy server 130 identifies the application based on the received metadata. As noted above, in one embodiment, S350 includes matching the information contained in the received metadata against an app-index stored in a database 150.

At S360, the received metadata as well as the name and type of the identified application are saved in the database 150. The information of the identified application can be saved together with the unique identification of the mobile device launched the application. In S370, it is checked whether there are additional requests and if so, execution continues with S310; otherwise, execution terminates.

The embodiments disclosed herein can be implemented as hardware, firmware, software, or any combination thereof. Moreover, the software is preferably implemented as an application program tangibly embodied on a program storage unit or tangible computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. All or some of the servers maybe combined into one or more integrated servers. Furthermore, a non-transitory computer readable medium is any computer readable medium except for a transitory propagating signal. The display segments and mini-display segments may be shown on a display area that can be a browser or another other appropriate application, either generic or tailored for the purposes described in detail hereinabove.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

1. A method for uniquely identifying an application executed on a mobile device, comprising:
trapping a request to execute an application by the mobile device, wherein the request is initiated by the application and directed to an Internet resource associated with the application;
identifying a source of the request;
generating metadata respective of the application that initiated the request; and
sending the metadata to the a proxy server communicatively connected to the mobile device, wherein the proxy server is configured to uniquely identify a name and a type of the application by matching information in the metadata to an app-index.

2. The method of claim 1, wherein the generation of the metadata is performed by an agent installed on the mobile device.

3. The method of claim 1, wherein the metadata includes at least one: a bundle name of the application, a hypertext transfer protocol (HTTP) header of the generated request, at least one network parameter included in the HTTP header, and an active socket assigned to the application.

4. The method of claim 1, wherein at least the name and type of the application are stored in a database.

5. The method of claim 1, wherein the identification of the source of the request further comprising:
querying the mobile device about an identity of an active socket assigned to the application.

6. A non-transitory computer readable medium having instructions therein that when executed by the mobile device performs the method of claim 1.

7. A method for uniquely identifying an application executed on a mobile device, the method is performed by at least a proxy server communicatively connected to the mobile device and a plurality of Internet resources via a network, comprising:
receiving a request for a network setting initiated by an application launched on the mobile device;
generating a customized proxy auto-config code;
sending the customized proxy auto-config code to the mobile device, wherein the execution of the customized proxy auto-config code by the mobile device allows accessing information stored in the mobile device about the launched application;
receiving a domain name server (DNS) generated responsive of the execution of the customized proxy auto-config code; and
analyzing the DNS request to identify at least a name and type of the launched application.

8. The method of claim 7, further comprising:
sending an IP address of at least one Internet resource of the plurality of Internet resources with which the launched application requests communication.

9. The method of claim 7, wherein communication with the mobile device is performed through a network interface of the device, wherein the network interface is configured to forward the request for the network setting initiated by the launched application to the proxy server.

10. The method of claim 9, wherein the request for the network setting includes at least a bundle name of the launched application.

11. The method of claim 7, wherein at least the name and type of the launched application are stored in a database.

12. A non-transitory computer readable medium having instructions therein that when executed by the mobile device performs the method of claim 7.

13. A proxy server configured to uniquely identify an application executed on a mobile device, wherein the proxy server is communicatively connected to the mobile device and a plurality of Internet resources via a network, comprising:
a first interface to any of the plurality of Internet resources to which the mobile device is communicatively connected via a network;
a second interface to a network interface of the mobile device;
a processor connected to the first interface and to the second interface; and
a memory connected to the processor and loaded with instructions that when executed by the processor cause the proxy server to:
receive a request for a network setting initiated by an application launched on the mobile device;
generate a customized proxy auto-config code;
send the customized proxy auto-config code to the mobile device, wherein the execution of the customized proxy auto-config code by the mobile device allows accessing information stored in the mobile device about the launched application;
receive a domain name server (DNS) generated responsive of the execution of the customized proxy auto-config code; and
analyze the DNS request to identify at least a name and type of the launched application.

14. The proxy server of claim 13, wherein the proxy server is further configured to send an IP address of at least one Internet resource of the plurality of Internet resources with which the launched application requests communication.

15. The proxy server of claim 13, wherein the network interface is configured to forward the request for the network setting initiated by the launched application to the proxy server.

16. The proxy server of claim 15, wherein the request for the network setting includes at least a bundle name of the launched application.

17. The proxy server of claim 13, wherein the proxy server is further configured to store at least the name and type of the launched application in a database communicatively connected to the proxy server.
